(19) United States
(12) Patent Application Publication
(10) Pub. No.: US 2005/0069849 A1
(43) Pub. Date: Mar. 31, 2005

(54) Computer-based method of improving reading comprehension

(75) Inventors: Lara McKinney, Basking Ridge, NJ (US); Stephen Yawger, Basking Ridge, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: IODE Design, Basking Ridge, NJ (US)

(21) Appl. No.: 10/954,000

(22) Filed: Sep. 29, 2004

Related U.S. Application Data
(60) Provisional application No. 60/507,748, filed on Sep. 30, 2003.

(51) Int. Cl. G09B 1/00; G09B 17/00

(52) U.S. Cl. 434/178

(57) ABSTRACT

Methods and programs are disclosed for a computer-based method of teaching reading comprehension skills in connection one or more pre-selected books, the computer program providing a selection of before-reading, during-reading and after reading exercises to be completed by a student in association with the pre-selected book. The exercises are tailored to the particular book by integrating details of book's author, characters, plot, setting, theme, point of view and the like. Before-reading exercises can include preview, connect, purpose and plan exercises; during-reading exercises can include timeliness character maps, puzzles, question and answer problems, summaries and the like; and after-reading exercises can include summary, discussion, question and answer, timeline, reflection exercises and the like. The method involves completing one or more of the before-reading exercises, reading a portion of the book and completing one or more of the during reading exercises corresponding thereto, completing the book followed by completing one ore more of the after-reading exercises.

### CROSS-REFERENCE TO RELATED APPLICATIONS

This application claims the benefit of the filing date of U.S. Provisional Patent Application No. 60/507,748 filed Sep. 30, 2003, the disclosure of which is hereby incorporated herein by reference.

### FIELD OF THE INVENTION

The present invention relates generally to computer programs and computer-implemented methods to assist in the teaching of reading comprehension skills, and, more particularly, to a computer program and computer-related methods that allow students to gain proficiency in reading comprehension by providing before-reading, during-reading, and after-reading exercises to be completed in association with a pre-selected book.

### BACKGROUND OF THE INVENTION

The teaching of reading comprehension is designed to provide students with tools and techniques they can employ to improve their understanding and retention of the written word. Developing good reading skills is essential to a student's progress in other subjects, such as science and history, where so much of the material learned is done by reading. In fact, few other subject areas are as universally important to a student, both in the classroom and throughout his or her lifetime.

In today's classrooms, teachers are being placed under greater pressure and time constraints as class sizes continue to increase. As a result, teachers have less time to provide individualized attention. Too often, they have limited time to tap into each student's individual learning style, leading, at times, to a “one size fits all” teaching strategy. In addition, time limitations may require a teacher to skip certain aspects of the teacher's curriculum. Further, in some instances, a standardized curriculum is not followed. As a result, some students may not be getting the reading comprehension skills they require to succeed. A need therefore exists for a method of teaching reading comprehension that provides a consistent education, and allows the students to work autonomously, freeing teachers to devote their time where it is needed.

Classroom reading comprehension is typically taught by providing a student with one or more books, typically selected by the instructor or school as appropriate for a particular reading level, and providing a student with one or more exercises to be done in association with the books selected. Those skilled in the art will recognize that there are a vast variety of exercises and activities available. Examples of such exercises can be found in the Reader's Handbook: A Student Guide for Reading and Learning by Laura Robb, Ron Klemp and Wendell Schwartz (2002), the contents of which are hereby incorporated by reference.

Over more recent years, computers have become increasingly used in the area of education, and many types of educational software are now available on the market. Applications have been designed to teach, for example, math, science, reading, vocabulary, typing, history, foreign languages and many other subjects. None of these programs, however, adequately addresses the teaching of reading comprehension along the lines of teaching methods that should be found in the classroom. Moreover, there remains a need for a reading comprehension program that provides students with feedback and teachers with a tool for evaluating the student's progress and proficiency at reading comprehension.

While computerized versions of books are currently available, for example, for a hand-held personal computer, many believe that there is more benefit and enjoyment that comes from reading from a “real” book. There exists, therefore, a need for a computer-based method that allows students to read from a conventional book, but provides the teaching benefits of a computing device.

### SUMMARY OF THE INVENTION

The invention is directed to a computer-based method and computing devices for teaching reading comprehension skills. In one embodiment, the computer-based method involves initiating a computer program that provides a selection of before-reading, during-reading and after reading exercises to be selected and completed by a student in association with a pre-selected book. The exercises can be tailored to the pre-selected book by incorporating aspects of the author, characters, plot, setting, theme, point of view or style thereof. Once the program is initiated, a user completes one or more of the before-reading exercises. The user then reads a portion of the book and completes one or more of the during-reading exercises corresponding thereto. Finally, the user completes the book and one or more of the after-reading exercises.

The before-reading exercises can include a preview, connect, purpose or plan exercise. The preview exercises can include a series of tasks to be completed, such as reading the title, information about an author, front and back covers, summaries or reviews, a preface, a table of contents, or chapter titles of the book, or viewing illustrations of the book. The preview exercise may be in the form of a checklist of these tasks, and the user inputs into a computer an indication that the tasks have been completed.

The before-reading exercises may also include a connect exercise wherein the reader is directed to identify a detail about the author, characters, plots, settings, themes, or title of the book that relates to a personal experience of the reader.

Preferrably, the purpose exercise directs the reader to identify a question relating to the book that the reader believes can be answered after reading from details about the author, characters, plots, settings, or themes of the book.

In another preferred embodiment, the before-reading exercise is a plan exercise. The plan exercise can be an explanation, instruction or tasks relating to techniques for organizing details of the books, such as the authors, characters, plots, settings, themes, point of view or styles of the book. In one embodiment, the techniques include a “5W” chart of “why”, “what”, “where”, “when” and “who” questions; a story organizer, a character map, a plot diagram, a timeline or a Venn Diagram.

In yet another preferred embodiment, the during-reading exercises can include a “5W” chart of “why”, “what”, “where”, “when” and “who” questions; a story organizer, a character map, a plot diagram, a timeline, a Venn Diagram or a game. The game can be, for example, a crossword puzzle, word find, word jumble, matching game, action video game, maze or decoder puzzle.

The program of the present invention can provide a menu from which the user selects the during-reading exercises corresponding to a portion of the book to be read. Preferably, the portion of the book corresponds to a chapter or group of chapters in the book.

In a further preferred embodiment, the after-reading exercises include one or more of a reflection exercise, summary exercise, discussion exercise, question and answer exercise, a chart of questions comrpising why, what, where, when and who questions; a story organizer for inputing information relating to the characters, settings, style, plots, points of view and themes of the book; a character map for inputing information relating to characters of the book; a plot diagram for inputing information relating a plot of the book; a timeline for inputing information relating to a sequence of events of the book; a Venn diagram; or a game. The reflection exercise may include a series of questions concerning the book directed to the reader. These questions can include, for example, “did you learn anything new?”; “which characters did you like, and why?”; “did you like the story and would you recommend it to a friend?”

In yet another preferred embodiment, the after-reading exercises include a summary exercise wherein the reader is asked to prepare a summary of at least a part of the book or draw a picture, the summary or picture including details of the characters, plots or settings of the book.

The after-reading exercises can also include a discussion exercise, wherein the reader is instructed to talk about the book with another person, and a question and answer exercise wherein a student is directed to complete a plurality of objective questions relating to the details of the authors, characters, plots, settings, themes, point of view, or styles of the book.

In a particularly preferred embodiment, the reading comprehension program is adapted to receive and store into a memory responses to each of the exercises discussed above that are entered by the user. The form of the response will depend on the particular exercise. For example, in one embodiment of a summary exercise, the user can be prompted to enter a written summary of the book or a portion of the book into the computer.

In another embodiment of the invention, the computer program can provide a number of sections, each section associated with a different book, and a user can select which book and associated exercises he or she would like or is instructed to complete. The book selections can be arranged, for example, by author, genre, time period, difficulty level or age-category.

The computer program can also be adapted to allow an instructor to customize the program, before-reading, during-reading or after-reading exercises by allowing the instructor to choose from a plurality of books, exercises, or difficulty levels. The instructor may also input customized explanations, instructions, tasks or questions as part of the before-reading, during-reading and after-reading exercises.

The computer program can also be customized to the particular student, the program being adapted to request and receive input of personal information relating to the student and store the personal information in a memory. One or more of the before-reading, during-reading, or after-reading exercises can then integrate the personal information of the student into the exercises.

In another embodiment, the computer program is adapted to evaluate a student's responses and can provide feedback to the student. The computer program can be adapted to compare the responses of the reader to the before-reading, during-reading and after-reading exercises to correct responses stored in a memory of the computer and provide the reader or an instructor feedback on the reader's performance.

The computer program can further provide one or more resources such as biographical information about the author, historical information about the settings, characters, or plots upon which the book is based, book reviews, a dictionary, a thesaurus, foreign language dictionary, encyclopedia, or maps. In a particularly preferred embodiment, the user can select one or more resources provided and review the information contained therein.

In another embodiment of the invention, a computer-based method of teaching reading comprehension to a student is provided, including presenting to the student on a display of a computer selections of pre-reading, during-reading and post-reading exercises associated with a pre-selected book to be read and comprehended by the student; selecting at least one of the pre-reading exercises on the computer, the pre-reading exercises including pre-reading comprehension activities specifically related to the pre-selected book, the pre-reading activities to be performed by the student prior to reading the book; displaying instructions for the reading comprehension activities to the student on the display; and having the student provide one or more responses to the pre-reading comprehension activities; selecting at least one of the during-reading exercises on the computer, the during-reading exercises including during-reading comprehension activities specifically related to the pre-selected book, the during-reading activities to be performed by the student based on portions of the book already read by the student; displaying instructions for the during-reading activities to the student on the display; and having the student provide one or more responses to the during-reading activities; and selecting at least one of the post-reading exercises on the computer, the post-reading exercises including post-reading comprehension activities specifically related to the pre-selected book, the post-reading activities to be performed by the student based on the student's reading of the entire book; displaying instructions for the post-reading activities to the student on the display; and having the student prepare one or more responses to the post-reading exercises.

The responses to the pre-reading, during-reading and post-reading exercises can also be electronically stored.

The present invention also provides computing devices for teaching reading comprehension. In one embodiment, a computing device for improving reading comprehension is provided that includes a user interface for communicating information to a user of the computing device; a user input device; and a processor provided with a computer program that causes the computer to: display before-reading, during-reading, and after-reading exercises to be completed in association with a pre-selected book, at least one of the exercises specifically corresponding to details of a author, character, plot, setting, theme, point of view, or style of the pre-selected book. In a preferred embodiment, the computing device can be a PC, PDA, cell phone or gaming console.

In another embodiment of the invention, a system for improving reading comprehension skills is provided that includes a server computer; a plurality of user computers connected to the server computer via a communications network, each of the user computers comprising a user interface for communicating information to a user of the user computer, a user input device, a display device, and a processor; wherein the server computer comprises a processor programmed to send instructions via the communications network to the user computers, the instructions causing the processor of the user computer to display before-reading, during-reading, and after-reading exercises to be completed in association with a pre-selected book, the exercises specifically corresponding to details of a author, character, plot, setting, theme, point of view, or style of the pre-selected book.

### BRIEF DESCRIPTION OF THE DRAWINGS

FIG. 1 is an exemplary flow chart of a computer program that can be used in accordance with the present invention.

FIG. 2 depicts the content of an exemplary start-up screen of a computer program used in accordance with the present invention.

FIG. 3 depicts the content of an exemplary screen displaying the various sections provided by a computer program of the present invention.

FIG. 4 depicts the content of an exemplary screen instructing use of the icons for the various sections of the present invention.

FIG. 5 depicts the content of an exemplary Before-Reading menu.

FIG. 6 depicts the content of an exemplary screen for Before-reading Preview exercises.

FIG. 7 depicts the content of another exemplary Preview Exercise screen.

FIG. 8 depicts the content of yet another exemplary Preview Exercise screen.

FIG. 9 depicts the content of the exemplary Preview Exercise screen of FIG. 8 with further indication of completion of exercises.

FIG. 10 depicts the content of an exemplary Connect Exercise screen.

FIG. 11 depicts the content of an exemplary Purpose Exercise screen.

FIG. 12 depicts the content of another exemplary Purpose Exercise screen.

FIG. 13 depicts the content of a further exemplary Purpose Exercise screen.

FIG. 14 depicts the content of an exemplary Plan Exercise screen.

FIG. 15 depicts the content of an exemplary Plan Exercise screen introducing graphical organizers.

FIG. 16 depicts the content of another exemplary Plan Exercise screen introducing additional graphical organizers.

FIG. 17 depicts the content of an exemplary screen beginning the During-Reading exercises for a portion of a selected book.

FIG. 18 depicts an exemplary screen for use in connection with an audio presentation of a portion of a selected book.

FIG. 19 depicts an exemplary screen for use in connection with an audio presentation of a portion of a pre-selected book.

FIG. 20 depicts an exemplary During-Reading exercise screen in the form of a Character Tree.

FIG. 21 depicts another exemplary During-Reading exercise screen in the form of a Character Tree.

FIG. 22 depicts a further exemplary During-Reading exercise screen in the form of a Character Tree.

FIG. 23 depicts an exemplary During-Reading exercise screen in the form of a Crossword Puzzle.

FIG. 24 depicts another exemplary During-Reading exercise screen in the form of a Crossword Puzzle.

FIG. 25 depicts an exemplary dictionary screen.

FIG. 26 depicts a further exemplary During-Reading exercise screen in the form of a Crossword Puzzle.

FIG. 27 depicts an exemplary During-Reading exercise screen in the form of a Timeline.

FIG. 28 depicts another exemplary During-Reading exercise screen in the form of a Timeline.

FIG. 29 depicts an exemplary menu screen for selecting During-Reading activities corresponding to various chapters of the book.

FIG. 30 depicts an exemplary screen beginning the During-Reading exercises for a given chapter of the selected book.

FIG. 31 depicts an exemplary menu screen beginning the After-Reading exercises.

FIG. 32 depicts an exemplary After-Reading exercise screen in the form of a Reflect exercise.

FIG. 33 depicts an exemplary After-Reading exercise screen in the form of a Summerize exercise.

FIG. 34 depicts another exemplary After-Reading exercise screen in the form of a Summerize exercise.

FIG. 35 depicts yet another exemplary After-Reading exercise screen in the form of a Summerize exercise.

FIG. 36 depicts an exemplary After-Reading exercise screen in the form of a Discussion exercise.

FIG. 37 depicts an exemplary screen used in connection with an After-Reading exercise in the form of a Question and Answer exercise.

FIG. 38 depicts an exemplary screen used in connection with printing the completed exercises and/or student responses.

FIG. 39 depicts an exemplary menu screen for selecting from various resources provided by the application.

FIG. 40 depicts an exemplary menu screen for selecting from various organizers provided by the application.

FIG. 41 depicts an exemplary Timeline screen.

FIG. 42 depicts an exemplary Venn Diagram screen.

FIG. 43 depicts an exemplary Character Map screen.

FIG. 44 depicts an exemplary Plot Diagram screen.

FIG. 45 depicts an exemplary Story Organizer screen.

FIG. 46 depicts an exemplary “5W's” organizer screen.

FIG. 47 is a schematic diagram showing exemplary electronic devices that can be used in accordance with the present invention.

### DETAILED DESCRIPTION

The present invention is directed to a computer-based method of teaching a student reading comprehension skills. In general, a computer program is employed to provide before-reading, during-reading and after-reading exercises which are designed to improve reading comprehension skills with respect to the particular book-selected, and, more importantly, to teach long-lasting skills that will assist the student in reading comprehension throughout his or her lifetime.

The computer-based teaching program in accordance with the present invention provides many advantages over conventional teaching methods that are typically employed in connection with reading comprehension. One benefit is that by employing a computer program, students can proceed relatively autonomously, freeing teachers to provide more individualized attention to a greater number of students. The computer program can also be used for self-teaching, for example, in connection with a summer reading program, or they can be integrated into a classroom setting. For example, students can work co-operatively to complete the exercises provided by the computer program, as partners or in small groups. Teachers can also instruct students as they use the program, providing additional exercises to supplement those of the program, engaging the students in discussion, and answering any questions that the students may have. Another benefit of the present invention is its ability to store and provide at an instant a vast amount of information to the student for use in teaching reading comprehension skills. For example, the present invention provides various resources, such as electronic dictionaries, biographical information about a particular author, summaries of the book being read, historical information that relates to the characters or settings of the book, maps corresponding to story settings, and the like. All of these resources are preferably provided by the program so as to be instantly accessible while the student is reading the book or performing the reading comprehension activities.

The use of the computer program of the present invention also makes learning more enjoyable, and, therefore, makes the educational process more effective. These and other advantages of the computer-assisted reading comprehension method of the present invention will be made apparent as detailed embodiments of the invention are described herein.

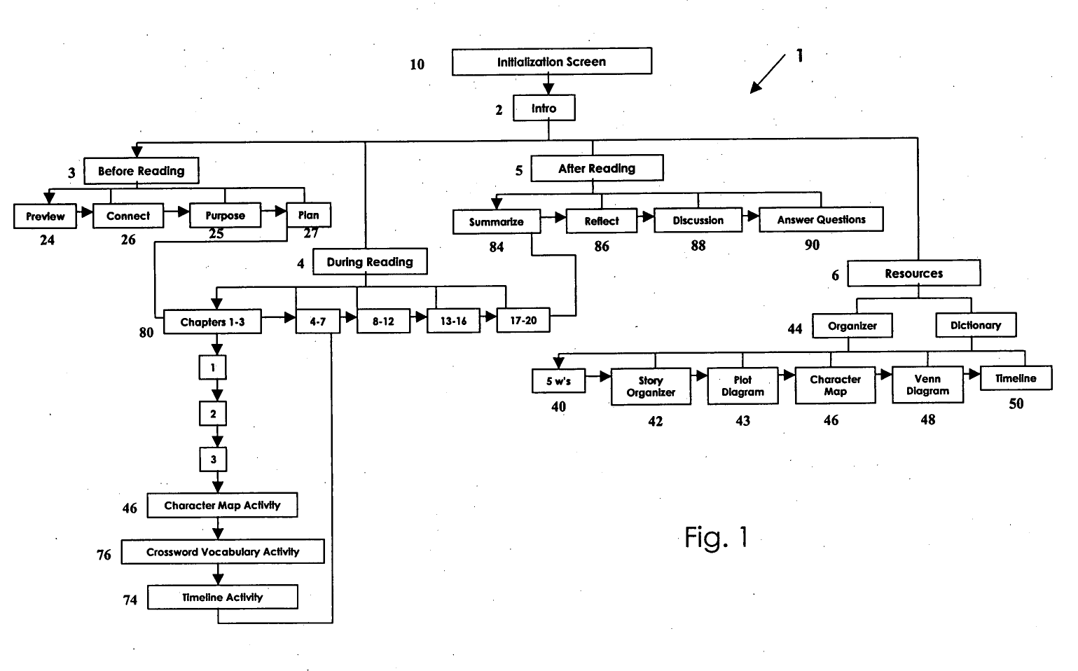

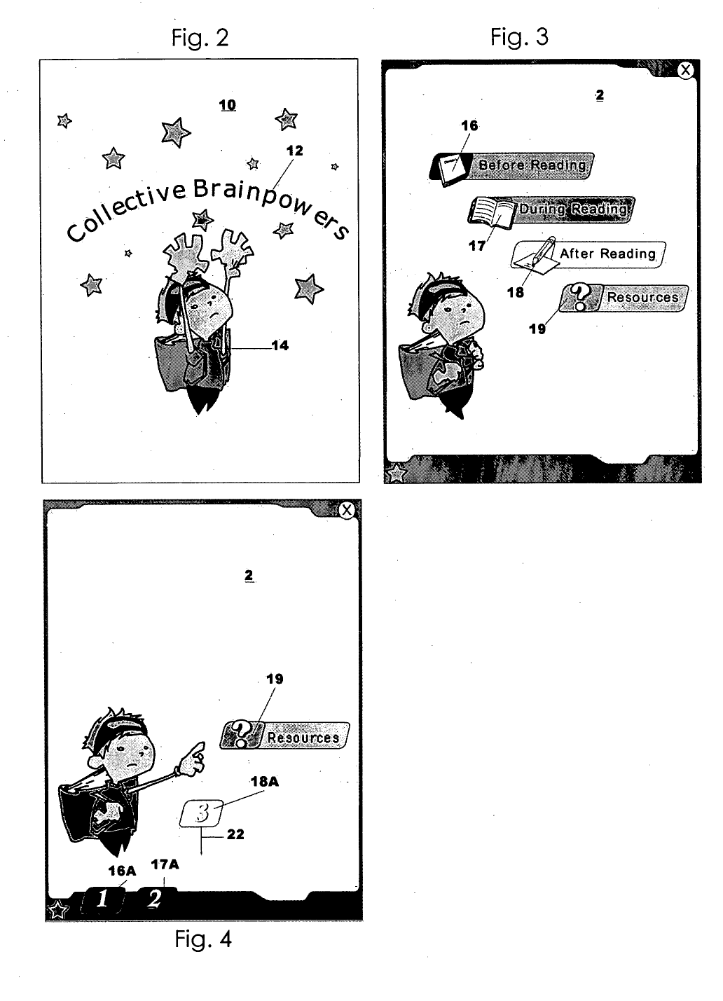

FIG. 1 is an exemplary diagram broadly illustrating the components and operation of a computer-assisted reading comprehension program of the present invention. As shown, the computer program 1 includes an introduction 2, before-reading exercises 3, during-reading exercises 4, after-reading exercises 5, and, optionally, one or more resources 6. The term “exercises” refers to one or more activities or tasks the student is asked to perform, and can include one or more instructions, examples, explanations, demonstrations, directions and the like to assist the student and explain what the exercise entails. Further aspects of the diagram shown in FIG. 1 will also be discussed in the paragraphs that follow in connection with the examples shown in FIGS. 2-46.

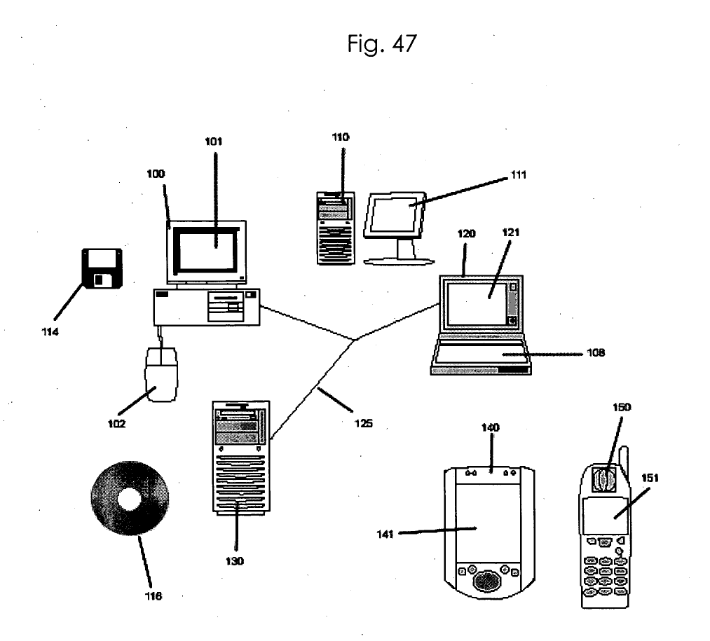

After the software has been initiated on the computer or other computing device (examples of which are shown in FIG. 47), a start-up screen or initialization screen 10 is preferably displayed, an example of which is depicted in FIG. 2. The start-up screen can depict a logo and/or software title 12, an illustration 14, company information (not shown) or other indicia. In one embodiment, the start-up screen 10 can also provide for input of a username and/or password by a user to access the program or an account which stores a student's previously entered responses to the various exercises. Preferably, when a student enters his or her password, the program will bring the student to his or her last position within the program. In another embodiment, an instructor may be provided with a username and/or password to view a student's progress or to customize the program.

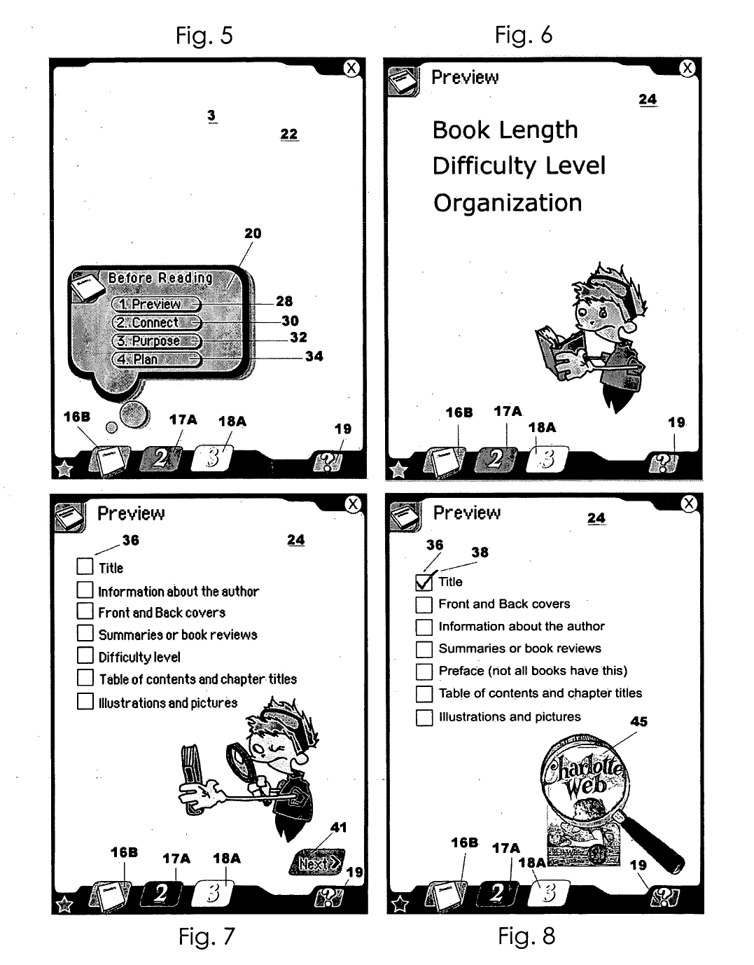

The program then progresses to one or more introduction screens 2, examples of which are depicted in FIGS. 3-4. The user can then select the menu items being presented by traditional manners such as by input keys, touchscreens, a mouse, a stylus, and the like. In one embodiment, the introduction screen 2 is to explain how to use the application. Preferably, either audibly and/or visually, the introduction 2 provides information introducing various sections of the software, for example, the before-reading 3, during-reading 4, after-reading exercises 5 and/or resources 6, and provides an explanation thereof. Preferably, this is accomplished by simply providing an audio description accompanying the introduction screen 2. Optionally, one or more pop-up windows can provide additional information when, for example, a cursor is moved over the before-reading icon 16, during-reading icon 17, after-reading icon 18, or resources icon 19. The introduction 2 can also explain or demonstrate the use of the various menus 20, 80, 82 or icons 16-19 (e.g., FIGS. 5, 29, 31), and can provide basic instructions on the use of the computing device generally, for example, the use of a mouse 102 (FIG. 47) or stylus (not shown) to make selections. In the example depicted in FIGS. 3-4, the selection icons for before-reading 16, during-reading 17, after-reading 18, and resources 19 are displayed. The icons 16-19 will then drop down to the bottom of the screen as illustrated by the arrow 22 in FIG. 4. As each of the icons 16, 17, and 18 of FIG. 3 drop to the bottom of the screen, they revert to numeric icons 16A-18A as depicted in FIG. 4. For example, the “1” icon 16A corresponds to before-reading icon 16 in FIG. 3, depicted as a closed book. When the icons 16-18 drop to the bottom of the screen they become icon numbers 1-3 (16A-18A) (FIG. 4), while the resources icon 19 always remains a “?” as shown in FIG. 5. When a particular screen associated with before-reading, during-reading, or after-reading exercises is displayed, the icon 16A-18A associated with that screen reverts back to a picture icon 16B-18B to indicate to the user that either the before-reading, during-reading, or after-reading exercises have been selected (see, for example, FIGS. 5, 19, 31). For example, in FIG. 5, the before reading icon is a picture icon 16B, while the during-reading icon 17A and after-reading icon 18A are numeric icons.

Preferably, the introduction screen 2 will provide information as to the purpose and goals of the program, generally, to improve reading comprehension skills. For example, in a preferred embodiment, introduction screen 2 depicted in FIG. 3 will be accompanied by text or a voice recording such as: “There are three basic phases to reading comprehensibly. Before reading, during reading, and after reading. We have also included a resources section where you can find a dictionary and story organizers to help you while you read.”

Optionally, each time the program is started, a new tip with respect to proper reading comprehension skills can be provided as part of the text (or as audible information) on the introduction screen or as a pop-up window (not shown) The reading comprehension tip can also be selected randomly by the program from a database of such tips stored in a memory in the computer running the software. A tip might include, for example: “remember to pick a good location for reading that is quiet and has proper lighting”, or “reviewing the table of contents can give you a good idea of a book's content”; or “read with a purpose!”

Once any information associated with introduction screen 2 is presented, the program will progress to the before-reading section and the before-reading exercises 3. Referring again to the icons in FIGS. 3 and 4, at any time the user may click (if using a mouse 102) or otherwise select one of the icons to progress to the associated section. For example, selecting the icon 16A brings the user to the before-reading menu 20 as depicted in FIG. 5. Preferably, the program will not progress to a section until the user has selected a section via the icons 16A-18A or 19. At any time, the user can preferably proceed to other sections by selecting the icons 16A-18A and 19 if displayed at the bottom of the screen, even when the user is within another section.

Before-Reading Exercises

In accordance with the present invention, reading comprehension is broken down into a three-step process, before-reading, during-reading and after-reading, each having particular techniques associated therewith that can be employed to improve the student's reading comprehension. Aptly named, the before-reading exercises 3 address the development of reading comprehension skills or techniques that can be employed before a student actually begins to read. Preferably, the user will not be able to proceed to the next section or activity unless they have completed the previous sections, more preferably with correct responses.

As mentioned previously, the before-reading exercises 3 can be accessed by selecting the before-reading exercises icon 16A, which brings the student to the before-reading menu screen 22, an example of which is depicted in FIG. 5. At the same time, the icon in the bottom menu is changed to a picture icon 16B. The before-reading menu screen 22 can provide further instructions and/or an introduction to the before-reading exercises 3. For example, accompanying voice and/or text can include: “The first step to reading for comprehension is to prepare yourself for reading the story. Begin preparing yourself to read Charlotte's Web by clicking on the Preview button in the Before-Reading menu.” Typically, there are four sets of before-reading exercises 3 that are employed: preview exercises 24, purpose exercises 25, connect exercises 26 and plan exercises 27, as depicted in FIG. 1.

By previewing a book, a student can obtain a good deal of information even before they begin to read. This information can then be used to assist the reader in forming a plan for reading, identifying a purpose for reading, or to make a connection with the book prior to reading the substance thereof. For example, the reader may be asked to simply look at the title, read information about the author, read the front and back covers which may contain a synopsis or the opinions of others about the book, read the preface, read the table of contents and chapter titles, or view the illustrations or pictures on the front cover, or contained within the book. From these activities or tasks, the reader can obtain some idea as to the characters, plot, settings, theme or other aspects of the book.

Referring to FIG. 5, depicted is an exemplary screen depicting a before-reading menu 20 including preview exercises icon 28, connect exercises icon 30, purpose exercises icon 32 and plan exercises icon 34. Selecting one of these icons 28, 30, 32, or 34 directs the reader to one or more exercise screens. For example, selecting the preview exercise icon 28 brings the reader to one or more preview exercises 24 as depicted in FIGS. 6-9.

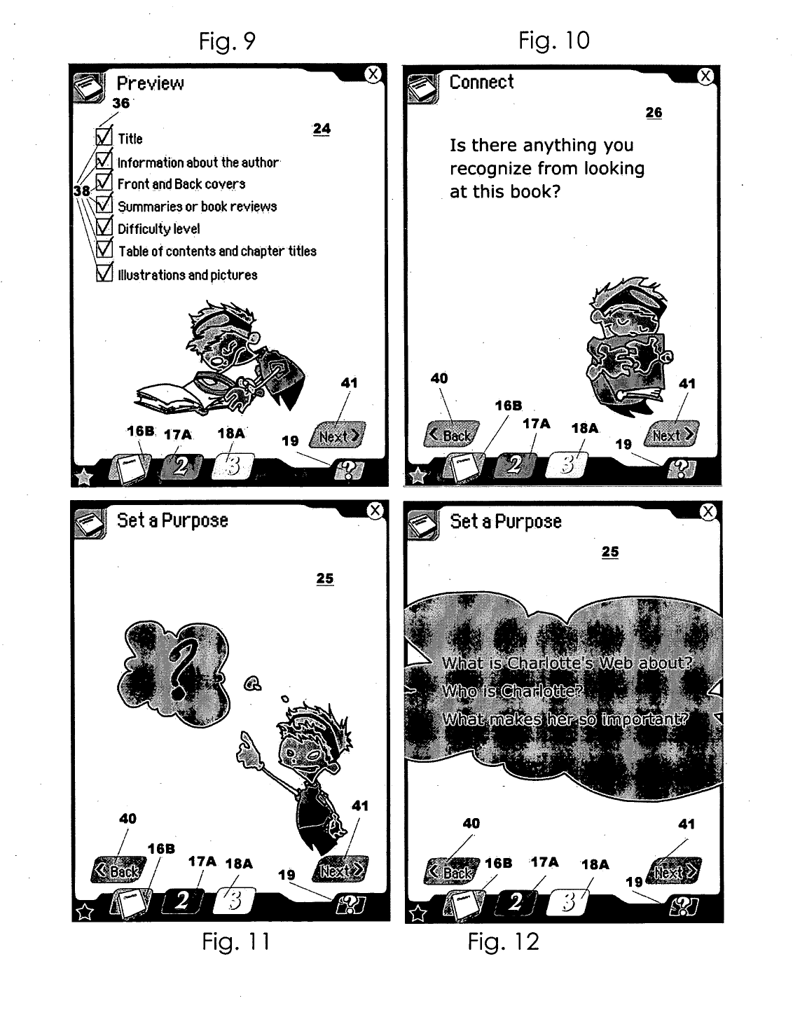

In FIG. 6, there is provided a preview screen displaying a preview exercise 24 that starts with an explanation of the importance of the preview exercise 24 and what information about the book can be found before reading has begun. For example, text or audio can be presented that states: “By previewing the book you can find your first bits of information. Such as book length, difficulty level, organization, and content.” The program progresses to the exemplary screen of FIG. 7, wherein the preview exercise 24, a task list 36 or set of directives, is displayed. A student can respond to the exercise by indicating that the task has been completed with a checkmark 38 (as depicted in FIGS. 8-9). A narrator can walk the student through the steps taken for preparing to read, and use of the task list. For example, the audio can state: “By using the preview checklist you can find out if this book is too difficult, too easy, or just right for you. Check off each task when you have completed it. Lets do the first one together.”

In FIG. 8, the preview exercise is demonstrating to the student the task of examining the title of the book, as shown by the preview illustration 45. There, the audio may state: “Always start by looking at the title of the book as well as the illustrations on the front and back cover. Once you have completed these tasks, make a check mark by circling in the empty box next to the task in the task list. The check mark is to let you know the task has been completed.” Preferably, when all the tasks have been completed (FIG. 9) the program directs the reader to proceed to the next exercise.

Other responses could include, for example, a typed summary of what the student uncovered as a result of performing the assigned tasks, for example, by summarizing information about the author, providing a short desription of what he or she thinks the story is about, identifying a chapter title he or she thinks is particularly interesting, providing a description of the illustrations, or simply providing notes taken by the student. In these instances, the program would provide an interface to allow such response to be entered into a text field or the like in the display of the computing device, for example, as depicted in FIG. 33 in connection with the summary exercises 84.

In another embodiment, the preview exercises 24 can utilize one or more resources 6 provided. For example, the student may be directed to read biographical information about the author; historical information about the settings, characters or plots upon which the book is based; a book review; or review one or more maps, illustrations or multi-media displays of text, video, animation, sound, or graphics. The resources 6 can be accessed at any point in the program by selecting the resources icon 19.

Another before-reading exercise 3 can be a connect exercise 26 as shown in FIG. 10. A connect exercise 26 requires that the reader, using information such as that previously discussed in connection with the preview exercises 24, identify details of the authors, characters, plots, settings, themes, or other aspects of the book that may have personal meaning to the student, or relates to an experience of the student. For example, an illustration on the cover might cause the student to identify the illustration with a pet that the student has, or a place similar to where the student lives or has visited, or perhaps the student has read another book by the same author. “Connect” exercises can be done as during-reading or after-reading exercises, however, they are preferred as a pre-reading exercise where it can be used to develop interest in the book and a reason for reading.

Referring to FIG. 10, an example of a connect exercise 26 screen is shown, wherein the student is asked to identify something they recognize from a preview of the book. As an example, the audio may state: “Now that you have completed the preview checklist, is there anything familiar you have seen. Have you ever read anything from this author? Do any of the pictures remind you of things you have seen before? For instance, have you ever visited a farm or seen farm animals? Or have you had any encounters with a spider? Thinking of these things will help you remember information about the story.” Here, the book to be read is Charlotte's Web. This set of instructions illustrates how the exercises can be tailored to a particular pre-selected book. That is, they “relate to” an author, character, plot, setting, theme, point of view, or style of the pre-selected book.

Preferably, another before-reading exercise is a purpose exercise 25. Purpose exercises 25 are designed to get the reader to think about why he or she is reading, and the information he or she wants to get from reading. In one embodiment, the purpose exercise 25 requires the reader to design one or more questions to be answered or keep in mind while reading.

In accordance with the present invention, the program presents the reader with screens such as those shown in FIGS. 11-13. The first screen, shown in FIG. 11, explains to the reader the purpose of the exercise, and can include an audio, for example, that states: “Now ask yourself a question that can be answered if you read the book. Finding the answer to your question will give you a good reason for reading.” Note that “back” 40 and “next” 41 icons are selectable to move forward and backward within the exercises.

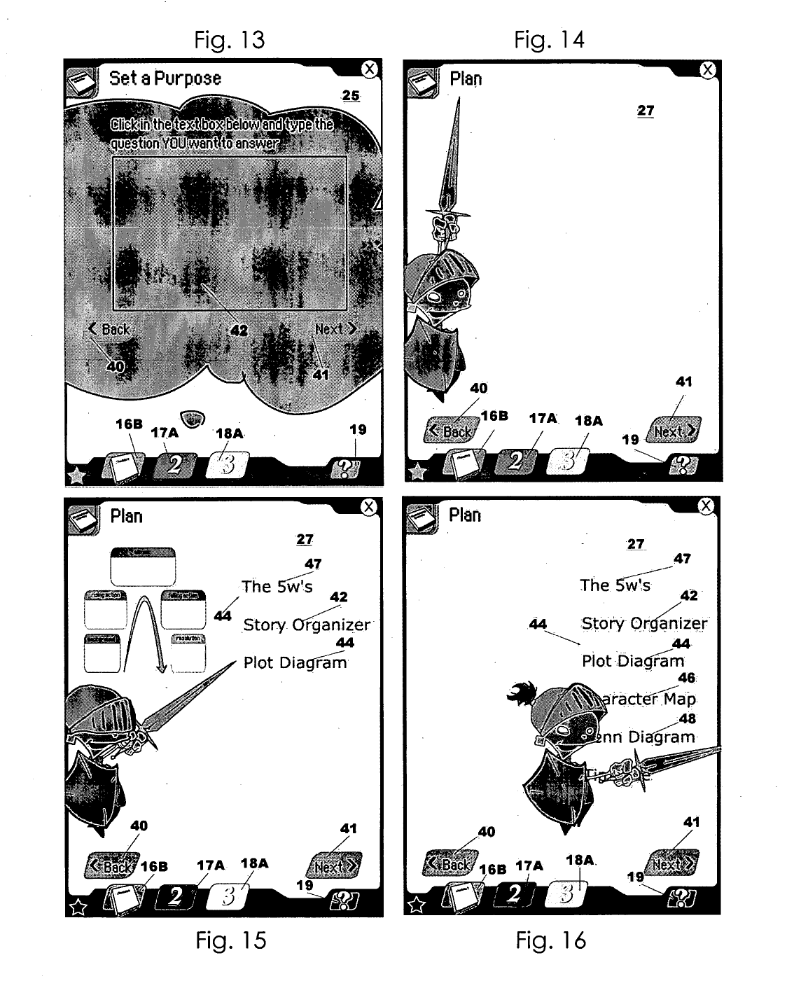

FIG. 12 demonstrates to the student how to generate questions as part of a purpose exercise 25, displaying questions related to the author, characters, plots, themes, point of view, settings or other details of the book. In one preferred embodiment, the student is asked to input a response in the form of written questions concerning a purpose for reading. This is illustrated in FIG. 13, wherein the computer program provides a text box 42 for input of the student's questions. Another example of a purpose exercise could include having a discussion with another student, a teacher or family member as to the purpose for reading with a summary response being entered into a computer.

Another pre-reading exercise 3 is preferably a plan exercise 27, examples of which are depicted in FIGS. 14-16. The plan exercises can be directed to introducing the reader to techniques for improving reading comprehension that he or she can employ, or should think about, while reading. Theses techniques are exemplified by a series of organizers 44, which can include, for example, a “5W” organizer 47, story organizer 42, plot diagram 44, character map 46, and Venn Diagram 48. The organizers are used as tools for use during-reading. Accordingly, they can be included as part of the plan exercises 27, wherein a menu is provided within the plan exercises 27 to access each of the organizers 44, or they can be associated with portions of the book as part of the during-reading exercises 4. In the example provided, however, the organizers 44 are provided in a separate section entitled resources 6, which will be described next.

Resources

Referring to FIG. 14, an example introduction screen to the plan exercises 27 is shown, which can include an explanation of the purpose of the plan exercises. For example, text or audio can provide: “Now that you know something about the book and why you are reading it, you need to develop a plan of attack. There are many ways of remembering information from a book. If you create graphical organizers while you read you can get a better understanding of what you are reading.” The application then continues with the exemplary screen of FIG. 15, which provides various plan techniques in the form of organizers 44, including, for example, The 5W's 47, Story Organizer 42, Plot Diagram 44, Character Map 46, and Venn Diagram 48. Text or audio at the plan exercise screen 27 explains the use of each of these tools to the reader. Another example of an organizer of the present invention is a timeline 50 (see FIG. 41).

The resources section 6 can provide various information, including, for example, biographical information about the author, historical information about the characters or settings, book reviews and summaries, maps and illustrations or pictures and other information that could be useful to the reader in better understanding the story and completing the exercises provided. However, the resources section 6 is also where the organizers that could be used in connection with the during-reading and after-reading exercises can be accessed. Again, in the example shown in the drawings, the resources section can be accessed at any time by selecting the resources icon 19 on the bottom of the menu.

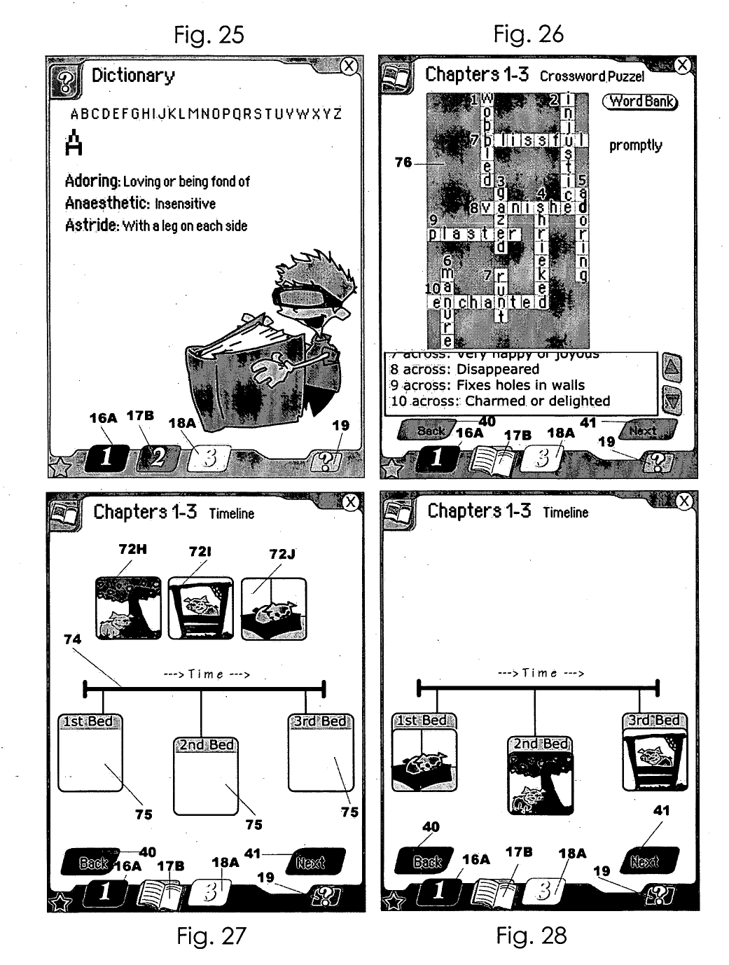

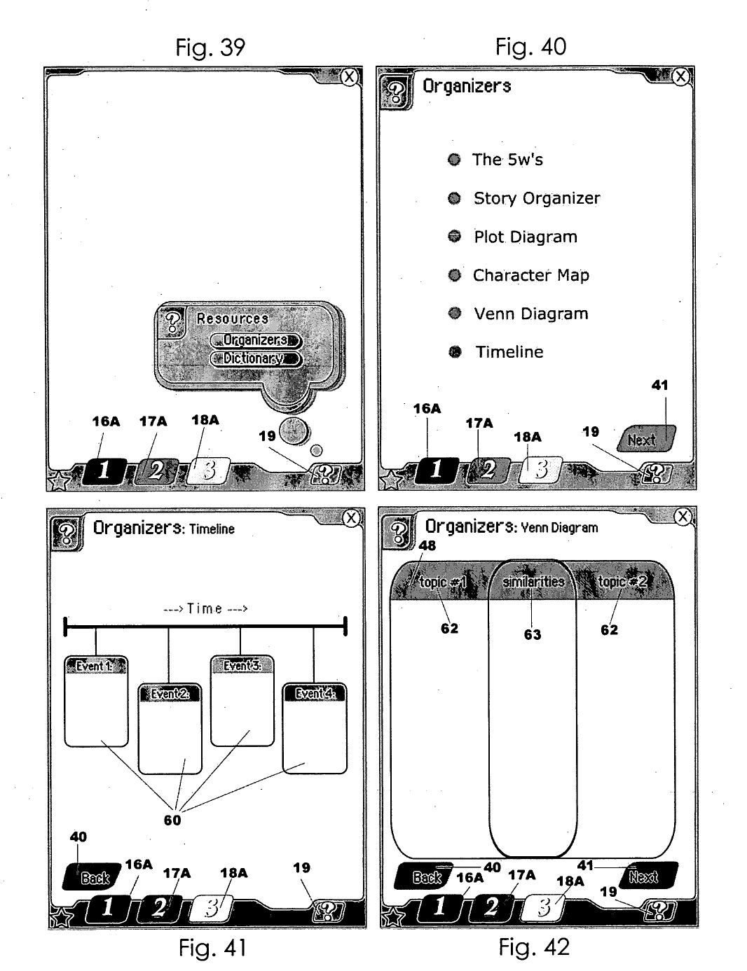

Referring to the example of the drawings, selecting the resources icon 19 brings the user to the resources menu page, as illustrated in FIG. 39. The resources menu 52 includes icons for selecting between the various resources provided, which, in this example includes a dictionary icon 54 and an organizers icon 56. Selecting the dictionary icon 54 brings the reader to an electronic dictionary (see FIG. 25), which can be a general dictionary, or can include only those words found within the book associated with the program. Another resource that could be provided is a thesaurus.

Selecting the organizers icon 56 from the resource menu 52 accesses the organizer menu 58 from which can be selected any of the organizers 44 (see FIG. 40). Optionally, the organizers menu screen 58 can present additional instructions on the use of each type of organizer.

Selecting the Timeline 50 from the organizers menu 58 brings the user to the timeline screen, an example of which is depicted in FIG. 41. One way of understanding and remembering the characters, plots and settings of a book is by organizing events that occur by time order. The timeline 50 provides a tool for organizing a sequence of events by allowing the user to input information relating the events into text boxes 60. The number of text boxes 60 can be fixed, or the user can add text boxes to the timeline as needed. In another embodiment, a number of pre-prepared entries can be provided along with the timeline 50, wherein the student is directed to put the pre-prepared entries in the appropriate sequence. In yet another embodiment, pictures, instead of text, illustrating particular events in the story, can be provided and the student can be directed to place (e.g., drag and drop) the pictures in the timeline, as shown in FIG. 27. This can be used to test, for example, the student's memory of events that have taken place in the reading.

One way of demonstrating the use of the timeline 50 and other organizers 44, is to present to the reader a paragraph or short story, and using this as an example with the various organizers provided. In one embodiment, this is done, for example, as part of the plan exercises 27. In another embodiment, one plan exercise will demonstrate the use of one or more of the organizers in connection with a sample paragraph, and a second plan exercise will have the student complete the same exercise with another exemplary short story or paragraph to solidify the concepts and insure that the reader has an understanding of the use of the organizers prior to reading the book.

In another embodiment, a Venn Diagram 48 is provided. Similar to the timeline 50, in the example provided, the Venn Diagram 48 may be accessed by selecting the Venn Diagram 48 from the organizer menu 58 (FIG. 40). The Venn Diagram can be used as a reading comprehension exercise to compare two characters, stories, settings and the like. A Venn Diagram will include two or more overlapping defined areas, each defined 62 area being used to place elements, for example, of different characters, stories, or settings. The areas common (overlapping) 63 to each of the defined areas enclose elements that are common to both. In this way, a student can readily compare two or more aspects of what he or she has read and determine similarities and differences. As part of a during-reading or after-reading exercise, the student may be directed to compare elements of book that is associated with the program and to another book he or she has read. This is a particularly useful exercise in the embodiment of the invention wherein a plurality of of different books are provided as part of the program, or in different programs each associated with a different book.

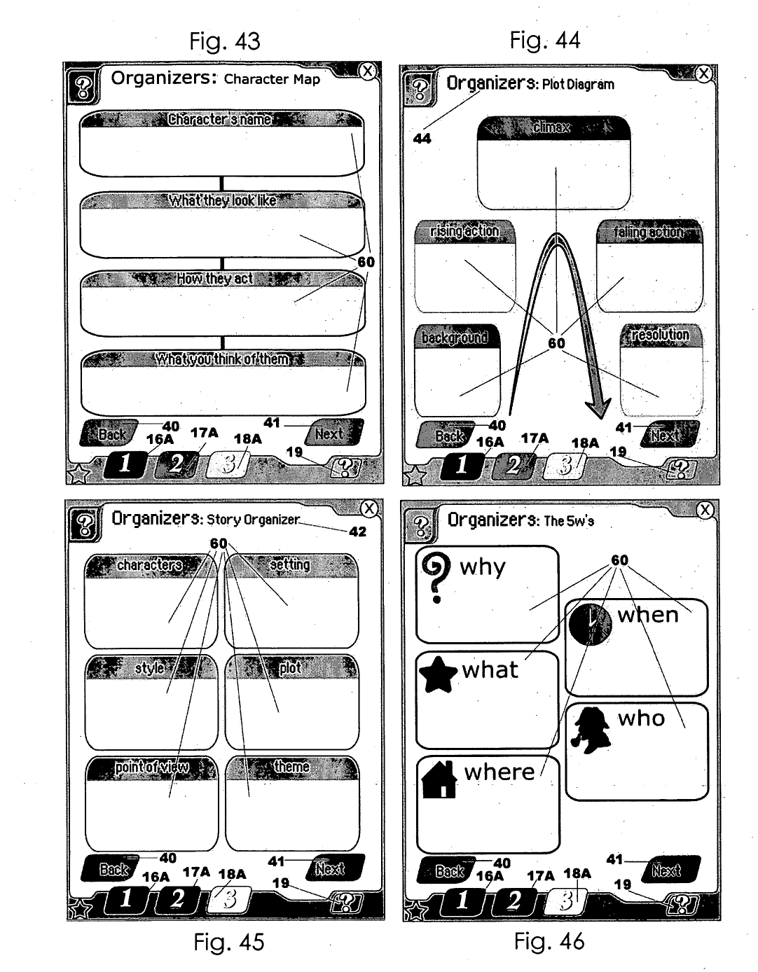

In another embodiment, the organizer 44 is a character map 46, an example of which is depicted in the screen of FIG. 43. A character map is used to summarize various aspects about characters of the book. Typically, more than one character map will be provided, optionally, the user can generate as many character maps as are needed according to the number of important characters in the book. In the embodiment depicted in FIG. 43, the character map simply consists of a series of text boxes 60, wherein the user can enter information relating to the character's name, what they look like, how they act, and what the reader thinks about the character. In another embodiment, the character name may be provided, and the student can be instructed to fill in information pertaining to that character.

In yet another embodiment, the organizer is a Plot Diagram 44 (FIG. 44) for showing how a story progresses. As depicted, the plot diagram has five parts: a background, rising action, climax, falling action, and resolution. The Plot Diagram 44 includes text boxes 60 associated with each of these parts of a story. Again, the user may be able to generate more than one plot diagram as needed. In one embodiment, the plot diagram relates to the details of a plot of the book associated with the program. For example, it may direct the student to enter information relating to a particular plot that occurs in the book, and may provide portions of information, for example, providing the names of characters or settings for the background.

In yet another embodiment, the organizer is a story organizer 42, an example of which is depicted in FIG. 45. The story organizer is used to organize information about the book. In the embodiment depicted, for example, text boxes 60 are provided for the student to enter information pertaining to the characters, setting, style, plot, point of view, and theme of the book being read. These organizers are particularly useful for comparing books that have been read. In one embodiment, where a plurality of books can be selected for reading, the program of the invention can be adapted to allow the reader to compare the story organizers 42 prepared from two or more of the books. In one embodiment, the program provides a side by side comparison of any two or more exercises or books that have been completed by the student.

Another embodiment of the invention includes a “5W” organizer 47, which is used to gather key information about a subject. The term “5W” refers to the five inquiries of “why”, “what”, “where”, “when” and “who”, as depicted in the example shown in FIG. 46. Each of the questions includes a separate text box 60 for inputing a response to each of the inquiries. As with the previous organizers 44 presented herein, the 5W organizer 47 screen can include examples for the student to follow, and can direct the student to answer these questions in connection with a particular aspect of the book being read.

The organizers presented herein are merely exemplary, and it should be recognized to those of skill in the art that a number of additional organizers could be employed within the scope of the present invention. For example, a number of such organizers are presented in the Reader's Handbook: A Student Guide for Reading and Learning by Laura Robb, Ron Klemp and Wendell Schwartz (2002), which is incorporated herein by reference.

In another embodiment, the program may include as a resource 6, or within the during-reading exercises, one or more vocabulary lists. These lists can be pre-determined, or they can be generated randomly by a database of words that are found in the book associated with the particular program 1. In another embodiment, an instructor can generate lists of words selected from those stored in a database provided by the computer program.

During-Reading Exercises

After the user has completed the before-reading exercises 3, and, optionally, reviewed the various organizers, the user can proceed to reading the book and the during-reading exercises 4.

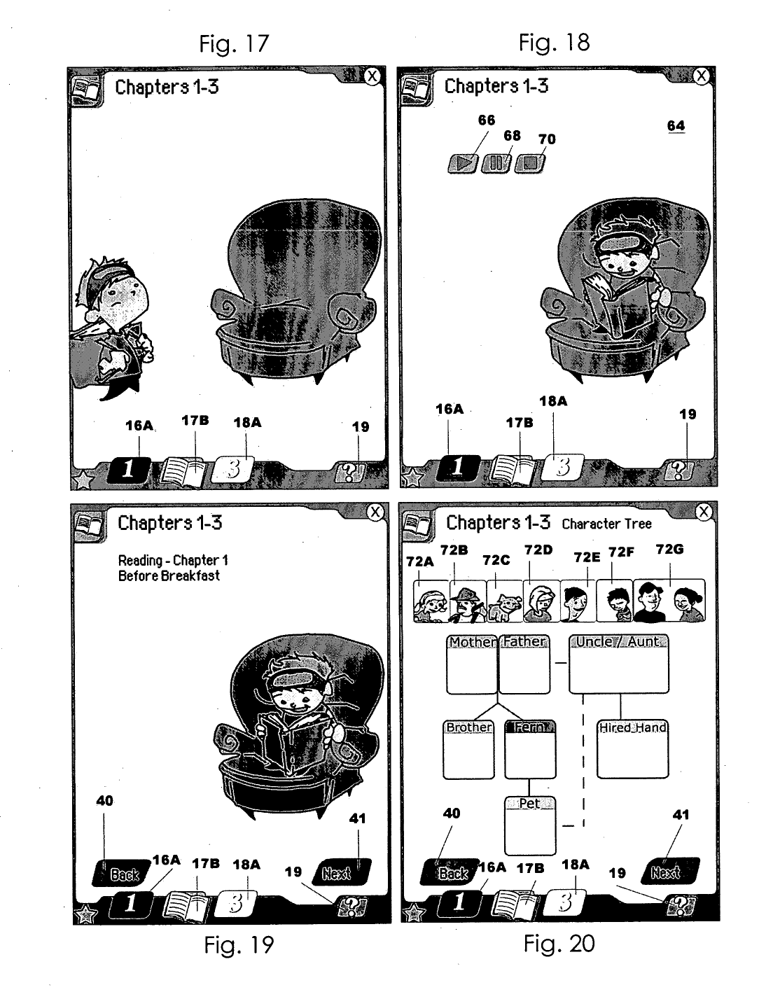

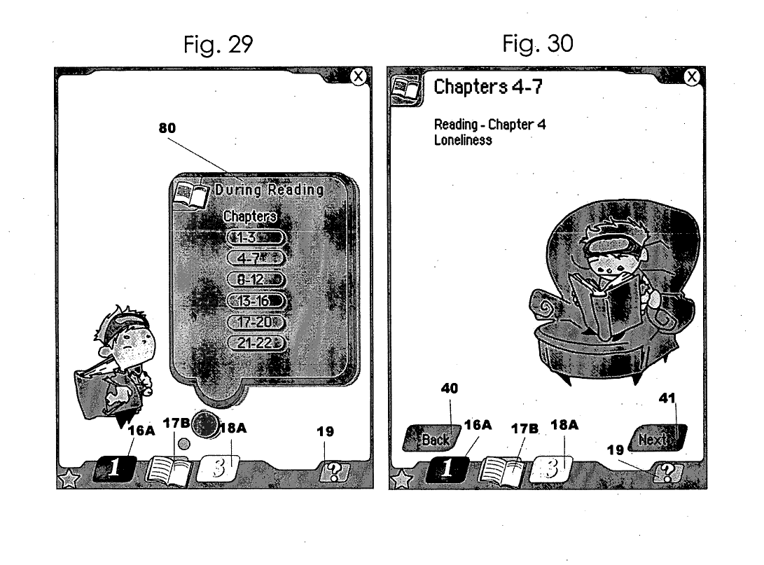

In the example provided, once the before-reading exercises 3 are completed, the application will immediately proceed to a during-reading exercises 4 and the during-reading exercises start-up screen, an example of which is depicted in FIG. 17. Optionally, a student can access the during-reading exercises by selecting the during-reading icons 17A. In another embodiment, instead of a start-up screen, the program can immediately progress to a during-reading menu screen such as that shown in FIG. 29.

In a preferred embodiment, the computer program of the present invention is designed to be used in connection with a paper book, hardback or paperback. Optionally, however, an electronic version of the book can be provided wherein the text, and, optionally, illustrations, front and back covers, tables of contents and the like, are displayed to the student. Optionally, both the reading comprehension program and the electronic book can be provided in a single device, such as a dedicated electronic device, a PDA, laptop computer or the like. In a preferred embodiment, the book can be presented in an audio format, in which case a control screen 64, such as that depicted in FIG. 18, can be provided. The control screen 64 can include icons such as a play icon 66, pause icon 68, stop icon 70, and, optionally, a rewind icon (not shown) and a forward icon (not shown). The control screen 64 can provide instructions, for example: “Use the play, pause and stop button to hear E. B. White tell the story of Charlotte's Web. Make sure you read along in your copy of the book. While you read try to make pictures in your head of what's happening in the story. You can also make notes, highlights, or use post-it notes while you read to keep track of important and interesting parts of the story.” Another example of a screen to accompany an audio presentation of the book is depicted in FIG. 19. An audio presentation has the benefit of keeping the readers attention and teaching the reader a proper reading rate and voice inflections.

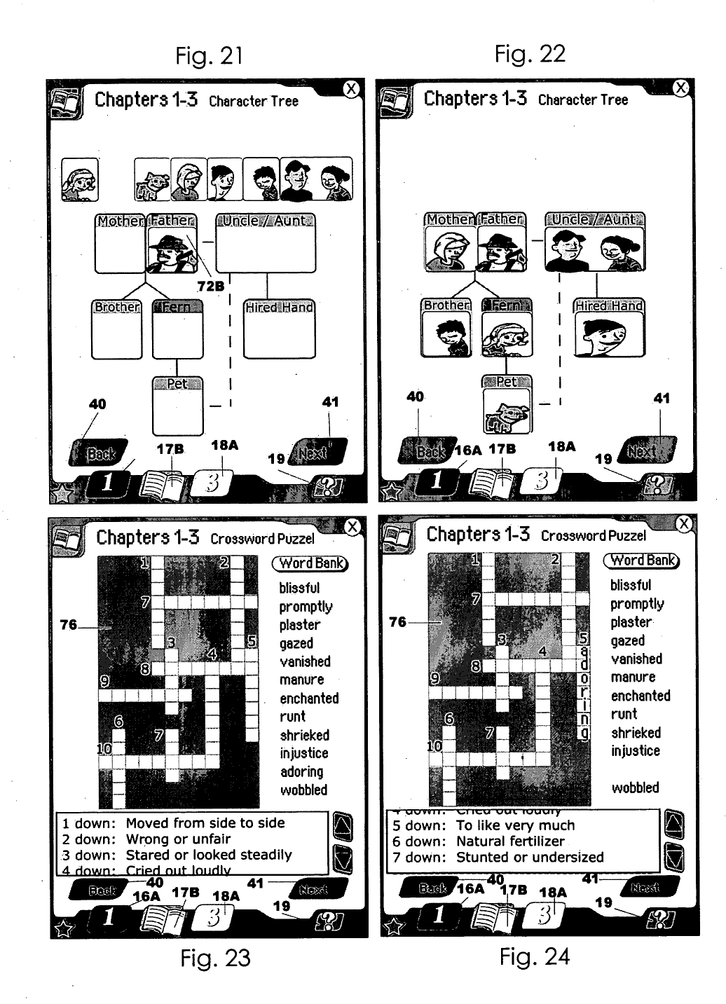

After reading a portion of the book, the reader will be directed to perform at least one during-reading exercise 4 corresponding thereto. In one embodiment, the during-reading exercise is a character tree, such as a drag and drop character tree depicted in the example screens of FIGS. 20-22. A character-tree is used to depict relationships between the characters in the book. Here, the exercise relates to details of the characters in the book, depicting the particular characters. The user drags the characters 72A-72G and places them in the proper relationship. In FIG. 21, for example, the picture 72B of the father character has been dropped into the appropriate position. In FIG. 22, all of the pictures 72A-72G have been moved by the user to the appropriate position. The pictures can also be associated with audio clips that include a quote said by or pertaining to the character from the book.

Text and or audio can be included to provide explanations or instructions, such as: “Remembering all the characters and how they are related to each other is very hard. To help yourself remember who they are and how they are related to each other, you can create a character tree. Here is a family tree of all the characters who have been presented so far. Look at and listen to each of the characters and then drag and drop the pictures of the characters in their correct boxes to complete the tree.” Further, the text or audio could include: “Lets place the first character in the correct box together. Who is the man with an axe? Do you remember anybody having an axe? Let's listen to the audio clip to get more clues. Fern, I know more about raising a litter of pigs than you do. A runt is nothing but trouble. That sounds like the father. Drag and drop the picture of the father into the box titled father.”

Yet another embodiment of a during-reading exercise 4 provided by the present invention is a game, for example, a crossword puzzle 76, word find, word jumble, matching game, action video game, maze or decoder puzzle. An example of a crossword puzzle 76 is depicted in the screens shown in FIGS. 23, 24 and 26. The crossword puzzle 76 develops vocabulary while encouraging use of a dictionary, such as that found in the resources 6. Audio instructions can accompany the crossword puzzle screens, for example: “Most times when you read a book there are words that you do not know. Use the dictionary in the resources section to find the definition of words you don't know. Here is a crossword puzzle to help you remember some of the hard vocabulary in Charlotte's Web. Drag and drop the words from the word bank to where you think they will go. Let's do the first one together. We should begin by taking a look at the word bank to see if there are any words that we already know. - - - Now let's take a look at the clues. 5Down—To like very much. That sounds like it is the clue for adoring. Let's look up adoring in the dictionary to see the definition. Click on the green button with a question mark to access the dictionary in the resources section.”

An example of the dictionary screen is provided in FIG. 25, which can include audio instructions, for example: “Click on the red letter A to get the definitions for all the vocabulary words beginning with an A. I see adoring, it means—Loving or being fond of. It is adoring. Click on the pink during reading icon to return to the crossword puzzle and then click on adoring and drag it to the correct spot on the puzzle. Great job. Now, complete the rest of the puzzle on your own.” An example of a screen showing the completed crossword puzzle is shown in FIG. 26.

Another during-reading exercise 4 of the present invention is a drag and drop timeline exercise as depicted in the exemplary screens of FIGS. 27-28. The drag and drop timeline 74 includes several boxes 75 where the pictures 72 are to be placed in chronological order. This helps the student remember a sequence of events of the book by presenting those events visually. Instructions accompanying the drag and drop timeline can include audio instructions as follows: “Sometimes it helps to reread the text to remember the details. This can be done much faster if you underline and mark notes in your text or on post-it notes when you read. Then you know where to go back to find information in the story. Because Wilbur keeps getting bigger his bed was moved a few times to give him more room. Reread the text to find out how old Wilbur was each time his bed was moved. When you're done, drag and drop the pictures of Wilbur's bed into the correct position on the timeline.” FIG. 28 depicts the completed drag and drop timeline exercise.

The character tree, crossword puzzle and drag and drop timelines are examples of the numerous types of exercises, activities or tasks that can be employed in connection with the during-reading exercises. As another part of the during-reading exercises, for example, one or more of the organizers 44 found in the resources 6 of the example provided can be employed with the student being instructed to complete the organizer 44 while he or she is reading the book. For example, the student could be instructed to do a plot diagram 44 for a plot found in a particular portion of the book, do a character map 46 for a character based on a portion of the book, fill in a timeline 50, and/or do a 5W exercise based on facts found in a portion of the book.

The during-reading exercises can also include developing one or more vocabulary lists based upon the portion of the book having been read. Vocabulary lists can be pre-determined or randomly selected by the software from a database. Vocabulary exercises can include, for example, matching exercises, word finds, word jumbles, decoder exercises, as well as the crossword puzzles discussed earlier.

At the completion of the first during-reading exercises 4, the program will direct the student to the during-reading menu 80 (FIG. 29), which allows the student to select between two or more portions of the book to be read, each portion having its own set of during-reading exercises 4. Preferably, the portions of the book to be read correspond to the chapters of the book, or groups of chapters as shown in FIG. 4. For example, selecting chapters 4-7 brings the user to the start-up page for the corresponding chapter set, for example, as depicted in FIG. 30.

In another embodiment of the invention, the user is provided with an electronic journal. The electronic journal can be employed by the user to, for example, enter notes with respect to certain details of the characters, plots, themes, settings, or other aspects of the book being read. The electronic journal can also be used make notes concerning important thoughts or questions the reader has, or to input interesting or important quotes from the book. For example, a text box 60 (e.g., FIG. 33) can be incorporated into the exemplary screens of FIG. 18 or 19.

After-Reading Exercises

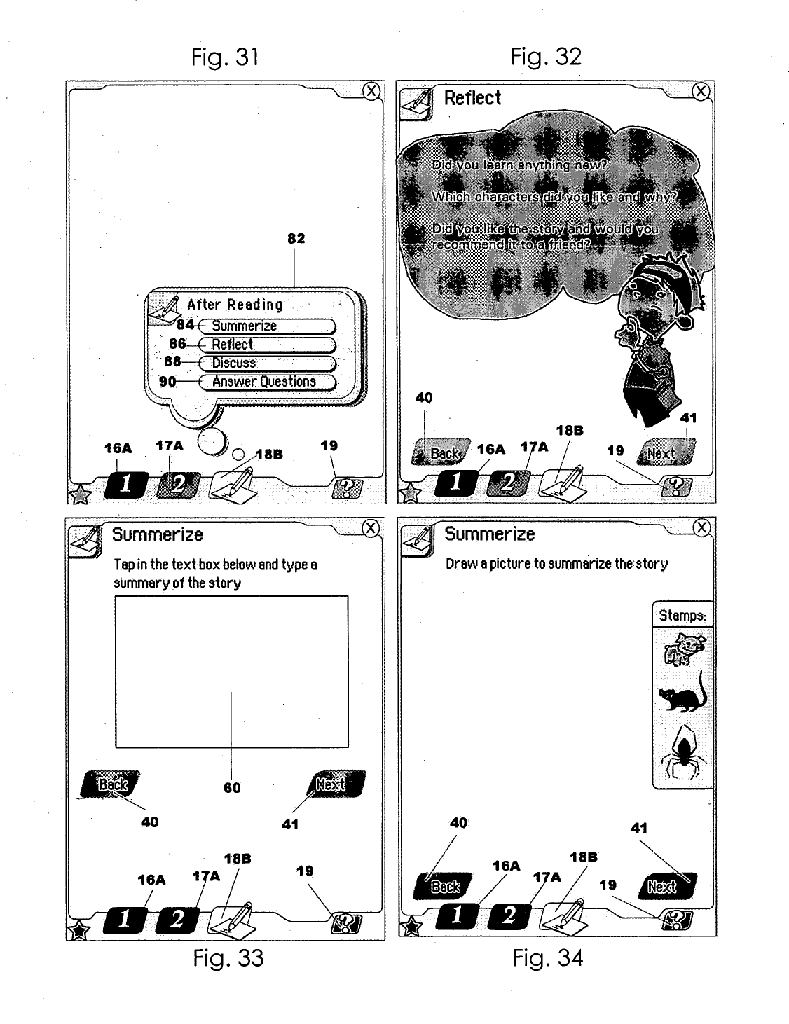

After completion of the book and of the during-reading exercises, the computer application presents the user with one or more after-reading exercises 5, which, in one embodiment exemplified in FIG. 31, can be accessed through the after-reading menu 82, which includes activity selections of summerize 84, reflect 86, discuss 88 and answer questions 90 (Question and Answer) exercises. The screen depicted in FIG. 31 can include accompanying textual or audio instructions, for example: “The last step to reading for comprehension is to reflect and react to the story. Did you find the answers to the questions you asked yourself before starting to read? How do you feel about this story and how does it compare to other stories you have read before? You can find the answers to these questions and the activities listed in this after reading menu.”

In one embodiment, the after-reading exercises 5 include one or more reflect or reflection exercises 86. Once the book has been completed, the reader should pause, look back, and reflect upon what he or she has read. Subjective questions such as: “Did I learn or find out something new from reading this book?”; “Is there any part of the book that remained unclear or confusing?”; “What was most interesting about the book to me?”; “Was there a character I particularly liked, and why?”, and the like can help the student to remember and understand what he or she has read. An example of a screen depicting a reflect exercise 86 is shown in FIG. 32. Audio or text instructions can accompany the screen, for example: “After reading the book take some time to reflect on the story. Ask yourself questions about the text and how you personally connected to it. Some good questions to start with are: Did you learn anything new? Which characters did you like and why? Did you like the story and would you recommend it to a friend?” In an alternative embodiment, the student could be asked to answer one or more such questions and input a response thereto in a text box (not shown) provided by the software. In yet another embodiment, the student could be directed to formulate both the questions and answers and enter them as a response.

In another embodiment, an after-reading exercise 5 is a summary or summerize exercise 84, wherein the reader is asked to prepare a summary of the story, or a part of the story, including details about the characters, plots or settings. In one example, depicted in FIG. 33, the summary exercise screen includes a text box 60 for entering a summary therein. Audio or textual instructions accompanying the screen can include, for example: “To help yourself remember the story, picture the important characters and events from the story in your head. Then, write a brief summary of the story in your own words.” In another embodiment, the summary exercise can include a task of preparing a letter to the student's instructor or a friend discussing their thoughts, feelings, and opinions about the book.

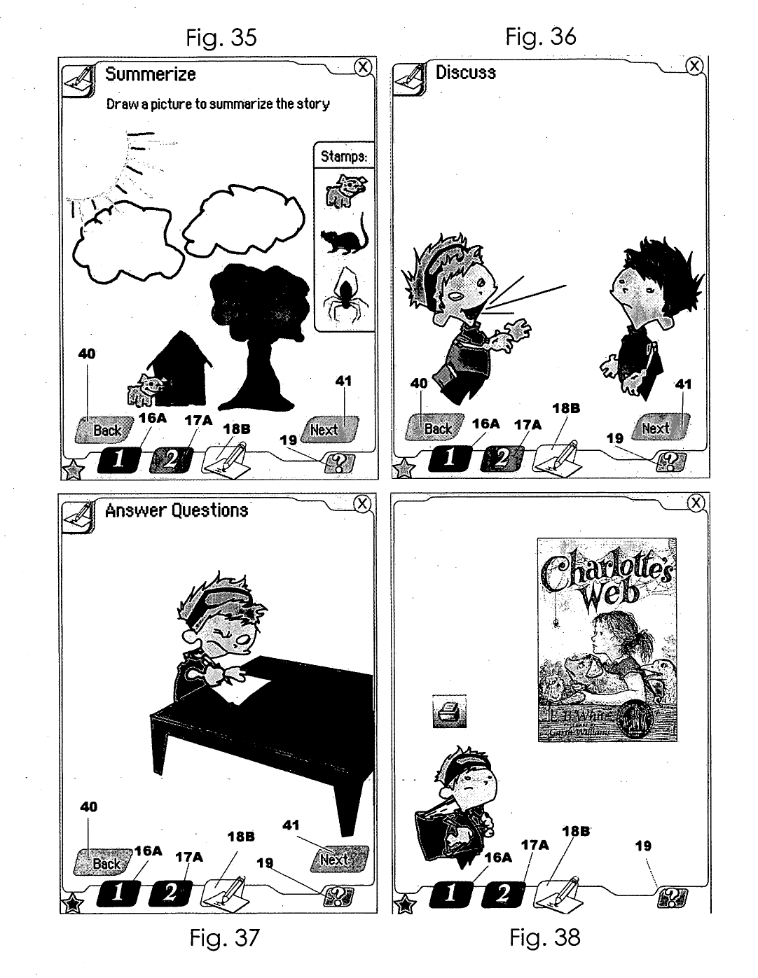

Other summary exercises 84 can include, for example, a drawing exercise 92, such as that depicted in the screen shown in FIGS. 34-35. The application integrates a simple paint program to allow the student to create a picture that summarizes the story or a part of the story. Instructions to accompany this page may include, for example: “To learn something about Charlotte's Web before reading the book we looked at the illustrations on the front and back covers of the book. The illustrations were the authors attempt to summarize the story. Picture an important person, time, or place from the story in your head. Then draw your own illustration of what you pictured. Drawing this illustration will help you remember details from the story and can be used as a communication tool when you talk about the book with other people.”

Yet another after-reading exercise 5 is a dicussion exercise 88. Discussing the book with other people is one way to improve a reader's understanding of the book, as other may people may have different perspectives based on their own experiences. An exemplary screen for a discussion exercise 88 is depicted in FIG. 36, and can include textual or audio instructions, such as: “Once you have taken the time to reflect on the story and have written your own summaries; you will have a few thoughts about the characters, the story, or even the author. Discuss your thoughts and opinions with your classmates. See how they felt about the story. Find out if their opinions differ from yours.” In one embodiment, the student could be asked to enter a response, including, for example, a summary of their conversation. This conversation could be held in person, or held electronically, for example, via an online or network chat room, or electronic mail.

A common way for students to test their memory and understanding of what they have read is to answer a series of objective questions relating to the book. This type of question and answer session also reinforces the students memory. Questions about, for example, the author, characters, settings, plots, themes, point of view, and style can all be included. Accordingly, in one embodiment, provided is a question and answer exercise 90 which will include a series of questions which can be either pre-determined, or selected randomly from a database of questions relating the book. An example of a question and answer exercise 90 screen is depicted in FIG. 37. The questions can be, for example, multiple-choice or fill-in type questions. The examination can also be timed, providing a set amount of time for the student to provide responses to a series of questions. The answers to the questions can be entered into the computer as a response, or can be done on paper to be turned into an instructor.

In a preferred embodiment of the question and answer exercise, the student is asked to answer questions which the reader previously entered in connection with the purpose exercises 25 done as part of the before-reading 3 exercises. Text or audio instructions may include, for example: “Go back to the Purpose section in the before reading activities and answer the questions you asked before starting to read Charlotte's Web. Did you find what you were looking for in the story? If you have questions that are still unanswered ask your teacher or classmates.” In another embodiment, the questions can be those entered by an instructor or simply provided by the software.

Those of skill in the art will recognize that the after-reading exercises presented above are merely exemplary, and that numerous other types of activities could be employed. Moreover, it should be noted that many of the activities described in connection with the during-reading exercises 4 can be employed as after-reading exercises 5, and vice versa. For example, a during-reading exercise could include having the student prepare a drawing or summary of the portion of the book he or she has read, reflect on the portion of the book, answer questions or have a discussion relating thereto. While the after-reading exercises could include a game, such as a crossword puzzle based on the reading in its entirety. Of course, the organizers 44 are considered to be both during reading and after-reading activities, and, to the extent they are part of the plan exercises 27, part of the before-reading 3 exercises as well.

While some of the exercises described herein with respect to the example provided do not include a response entered into a computer, one skilled in the art would readily recognize that the program could be adapted to include such a response. For example, the discussion or reflect exercise may include entering a summary of the discussion or answers to questions into a text box. The summary can be an artistic summary such as that depicted in FIG. 34.

At the end of the after-reading exercises, or whenever the software program is ended, a termination screen may be provided, for example, as depicted in FIG. 38. In one embodiment, the termination screen includes a print icon 94 that allows the student to print a record of his or her progress and/or responses, which can then be provided to an instructor. In another embodiment, the results can be sent via electronic communication to another person.

Book Selections

The computer programs and devices of the present invention are designed for use in connection with the reading of books commonly found in classroom reading lists. While a book may be provided in electronic format, either in text or audio format, with or without illustrations, in the preferred embodiment, the book is be provided as a printed or “real” book, for example, as a paperback or hardcover. Of course, the book, or a portion thereof, may be provided in electronic form in combination with the paper version.

The term “pre-selected” book, refers to the fact that the program of the present invention is tailored to specific books to be read. This is demonstrated by the example provided in FIGS. 8, 12, 20, 27, 30, and 35. The pre-selected book in the example provided is Charlotte's Web by E. B. White. Accordingly, the program is tailored to this book by including details about the characters, plots, themes, title, author and the like in the activities, instructions or demonstrations provided by the program. Of course, a generic version of the programs or devices of the present invention could be provided that could be used with books that are not pre-selected, however, in the preferred embodiment, the book will be pre-selected and the program tailored accordingly.

In a preferred embodiment, the reading comprehension program and exercises are directed to students of a third to fifth grade reading level, or those needing reading comprehension instruction in that designated reading level. Those skilled in the art will recognize that the present invention can be employed with a great number of books. However, the following is an exemplary list:

| TITLE | AUTHOR |
|---|---|
| Tar Beach | Faith Ringgold |
| Where the Red Fern Grows | Wilson Rawls |
| Island of the Blue Dolphins | Scot O'Dell |
| Julie of the Wolves | Jean C. George |
| Roll of Thunder, Hear My Cry | Mildred Taylor |
| Joyful Noise (Poems) | Paul Fleischman |
| Number the Stars | Lois Lowry |
| White Fang | Jack London |
| The Legend of Sleepy Hollow | Washington Irving |
| Freckle Juice | Judy Blum |
| My Father's Dragon | Ruth Stiles Gannett |
| Miss Rumphius | Barbara Cooney |
| Shiloh | Phyllis Naylor |
| The Wizard of OZ | Frank Baum |
| The BFG | Roald Dahl |
| The Trumpet of the Swan | E. B. White |
| Old Yeller | Fred Gipson |
| Sounder | William Howard Armstrong |
| From the Mixed-Up Files of Mrs. | E. L. Konigsburg |
| Basil E. Frankweiler | |
| A Wrinkle In Time | Madeliene L'Engle |
| Tuck Everlasting | Natalie Babbitt |
| Fairy Tales | Brothers Grim |
| Everything on a Waffle | Polly Horvath |
| Mr. Popper's Penguins | Richard Atwater |
| Superfudge | Judy Blume |
| The Whipping Boy | Sid Fleischman |
| Sideways Stories from Wayside School | Louis Sachar |
| Summer Reading is Killing Me | Jon Scieszka |
| The Monster in the Third Dresser | Janie Lee Smith |
| Drawer | |
| Charlie and the Chocolate Factory | Roald Dahl |
| The Lorax | Dr. Seuss |
| Charlotte's Web | E. B. White |

In another embodiment of the invention, the program may be provided to be used in connection with two or more pre-selected books, and the student and/or instructor can select among the titles provided. In this manner, a student and/or instructor can create a curriculum of books or a summer reading list, each with its own specially tailored reading comprehension program. Optionally, the books can be selected from a list provided over the Internet, and book-specific exercises may be added to the computer program via download from the Internet.

Other Aspects of the Invention

One aspect of is the present invention provides for the ability of instructors and/or students to customize the program to suit their particular requirements and reading preferences.

At the simplest level, for example, an instructor may be able to select from among a list of titles provided by a computer program. As discussed above, the instructor may be able to choose a list of selections to create a curriculum or suggested reading list for his or her students. Of course, the student may be able to select the books to be read, alone, or at the direction of an instructor.

In another embodiment, the instructor may also select the type, number and level of difficulty of the before-reading, during-reading, and after reading exercises, and may even be able to customize certain exercises by inputing his or her own questions, instructions or explanations in addition to, or in place of, those provided by the program. For example, in a question and answer type activity, the instructor could select from among the questions provided, have them presented in a particular or random order, or add his or her own question to be displayed to a student using the particular program. In another embodiment, the program allows the instructor to insert additional screens that provide instructions, explanations, or activities to be performed, and may provide for the student to input a response, for example, in the form of a text box or checklist, to the instructors directions.

In another embodiment, as part of the before-reading, during-reading or after-reading exercises, vocabulary exercises may be provided. The computer program may allow an instructor to generate his or her own vocabulary lists based upon a database of words and definitions provided, or it may have a pre-determined selection or randomly choose the words from a database provided. In another embodiment, the instructor may provide both vocabulary terms and definitions, which may then be stored in the memory of a computer.

In one embodiment, the selections made by the instructor may be implemented on a group basis, for example, selecting the same exercises or books for all students in a class or group. However, in another embodiment, the instructor may tailor the difficulty level and selections to a particular student.

In another embodiment, at the beginning of the program, the student can be prompted to enter personal information, for example, name, age, height, weight, hair color, eye color, place of birth or residence, and the instructions and/or exercises can be tailored to the particular student. For instance, the program can address the student by using his or her name in the text or audio. In another embodiment, the information can be used in association with one or more of the exercises provided. For example, as part of the connect exercise, if the story takes place in Iowa, and the child lives in Oklahoma, a map could be provided that shows both locations, or, as demonstration of a character map, a character map could be provided with information about the child. In another example, the program could provide a description of the student based upon his or her description as an example of a character summary and ask the student to do the same for a specific character in the book.

Optionally, answers given by the student can be compared to correct answers located in a remote computer database, or provided by a teacher or the program and stored in the memory of the computing device that executes the program. By comparing the student's answers to the correct answers, the program can indicate when a student has provided a correct or incorrect answer, and, optionally, may indicate, visually or audibly, the correct answer. This allows students and/or teachers the opportunity to recognize difficulties a student may be having with particular areas of reading comprehension, and teaches students by demonstrating proper reading comprehension skills.

In another embodiment, the software provides an “progress tracker”, which indicates to teachers that the exercises provided by the program have been completed by the student and the level of success of the student. For example, the program may provide a screen which can be viewed by a teacher that has information relating to the student's progress. The screen may include information relating to the student's progress and/or difficulties with respect to particular exercises, or, when the program is used in connection with a collection of books, and not simply one book, the progress tracker can indicate the books and exercises completed with respect to each of the books, and, by comparing the student's success from exercise to exercise or book to book, the progress tracker can provide teachers and students with an indication of the strengths and weaknesses of the student with respect to certain reading comprehension skills. The progress tracker may be password protected so that it can be viewed only by the teacher.

To the extent that the program teaches vocabulary skills, the program can also indicate to teachers the level of success and student's knowledge with respect to vocabulary learned in connection with the book(s) read.

In yet another embodiment, wherein the program is employed in connection with a network or over the Internet, the program can be adapted to provide e-mail or a message board, wherein an instructor can communicate to students interactively, by providing assignments, instructions, explanations and answers to student questions. In yet another embodiment, students may be able to send e-mail or post comments and/or questions to instructors with respect to assignments, portions of the book(s) they have read, or the exercises provided.

In yet another embodiment, wherein the program is employed in connection with a network or over the Internet, students and/or instructors may be able to interact to complete assignments together. Students may participate, for example, in one or more games, working with, or competing against other students and/or an instructor.

Devices of the Present Invention

The program of the present invention can be used in connection with a number of electronic devices. The program can be operated by using a computer, such as a home computer, personal computer, school computer, laptop, cell phone, PDA, gaming console, or other device that can run programs (see FIG. 47). The program can be pre-recorded on a recording medium and delivered to a student, teacher or other individual by a disk 114, CD-ROM 116, over the Internet, included within the computing device, or by other methods which are known to those of skill in the art.

FIG. 47 is a schematic diagram of a computer network and various computing devices that can be used alone or in a networked configuration in accordance with the present invention. The devices may comprise computer-type devices employing various types of user inputs, displays, memories and processors such as found in typical PCs 100, 110, laptops 120, servers 130, gaming consoles (not shown), PDAs 140, cell phones 150, and the like. For example, computing devices 100, 110 and 120 are connected via a communications network 125, such as a LAN, WAN, the Internet, etc. and which can be wired, wireless, a combination thereof, etc. The program can also be run from a server, such as server 130, and distributed to a user computer over a network, such as over the Internet to user computers running web browsers such as Microsoft's Internet Explorer or Netscape Navigator.

Each computing device can include, for example, various types of user interfaces such as a keyboard 108, mouse 102 (or various other types of known input devices such as pen-inputs, stylus, joysticks, buttons, touch screens, etc.), a display 101, 111, 121, 141, 151, or a connector, port, card, etc. as a display interface for connection to a screen, monitor, projector and audio equipment or the like. Each computing device also preferably includes the normal processing components found in such devices such as one or more random and read-only memories and one or more processors for running the program. The memories and the processors used by such computing device are adapted to run the program, display the screens, provide the audio, accept user input, store user input, etc. as described herein. The memories can include memories for storing a program or instructions for causing the processor(s) of the computing device to perform the various aforementioned steps in accordance with the present invention.

In a preferred embodiment, the program of the preferred embodiment is employed in connection with a portable electronic device, more preferably a PDA 140 or the like. PDAs 140 have more versatility, and are most often less expensive than a laptop computer 120. The PDA 140 can be a general PDA 140, that can provide a number of functions, or can be a specific PDA which is designed to run only the programs of the present invention. This allows a student to take the computing device anywhere that the student desires to read.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-based method of improving reading comprehension skills, the method comprising:
initiating a computer program on a computer that provides a selection of before-reading, during-reading, and after-reading exercises to be selected and completed by a student in association with a pre-selected book to be read by the student, at least one of the exercises specifically relating to the pre-selected book's author, characters, plot, setting, theme, point of view, or style;
completing one or more of the before-reading exercises prior to reading the pre-selected book;
reading a portion of the book and completing one or more of the during-reading exercises corresponding to the portion that was read; and
completing the book and completing one or more of the after-reading exercises.

2. A method according to claim 1, wherein the before-reading exercises comprise one or more of a preview, connect, purpose and plan exercise.

3. A method according to claim 2, wherein the preview exercise comprises a series of tasks to be completed, the tasks comprising one or more of the following: reading a title of the book, reading information about an author of the book, reviewing front and back covers of the book; reading summaries or reviews of the book; reading a preface of the book; reading a table of contents of the book; reading chapter titles of the book; and viewing illustrations of the book.

4. A method according to claim 3, wherein the preview exercise further comprises a checklist of the tasks to be completed, the method further comprising inputing into a computer an indication that the tasks have been completed.

5. A method according to claim 2, wherein the connect exercise comprises a task wherein a reader is directed identify one or more details about the author, characters, plots, settings, themes, or a title of the book that relates to one or more personal experiences of the reader.

6. A method according to claim 5, further comprising inputing into a computer information corresponding to the identified detail and personal experience.

7. A method according to claim 2, wherein the purpose exercise comprises directing a reader to identify at least one purpose question that the reader believes can be answered from details about the author, characters, plots, settings, or themes of the book.

8. A method according to claim 7, further comprising inputing into a computer the at least one purpose question.

9. A method according to claim 2, wherein the plan exercise comprises an explanation, instruction or tasks relating to techniques for organizing details concerning the authors, characters, plots, settings, themes, point of view, or styles of the book, the techniques comprising a chart of questions comprising why, what, where, when and who questions; a story organizer for inputing information relating to the authors, characters, plots, settings or themes of the book; a character map for inputing information relating to the characters of the book; a plot diagram for inputing information relating the plots of the book; a timeline for inputing information relating to a sequence of events of the book; and a Venn diagram.

10. A method according to claim 9, further comprising the step of inputing into a computer information corresponding to the plan exercises, obtained by reading the book.

11. A method according to claim 1, wherein the computer program is adapted to present the book in visual or audio format.

12. A method according to claim 11, wherein the program provides a menu for selecting the portion of the book to be read, the method further comprising selecting from the menu the portion of the book and presenting the portion in visual or audio format to a reader.

13. A method according to claim 12, wherein the portion of the book corresponds to a chapter or group of chapters of the book.

14. A method according to claim 1, wherein the program provides a menu for selecting the during-reading exercises corresponding to the portion of the book, the method further comprising selecting from the menu the during reading exercises corresponding to the portion of the book.

15. A method according to claim 14, wherein the portion of the book corresponds to a chapter or group of chapters of the book.

16. A method according to claim 15, wherein the during-reading exercises comprise a chart of questions comprising why, what, where, when and who questions; a story organizer for inputing information relating to the characters, plots, settings, themes, point of view or styles of the book; a character map for inputing information relating to the characters of the book; a plot diagram for inputing information relating the plots of the book; a timeline for inputing information relating to a sequence of events of the book; a Venn diagram; or a game.

17. A method according to claim 1, wherein the during-reading exercises comprise a chart of questions pertaining to why, what, where, when and who; a story organizer for inputing information relating to the characters, plots, settings, themes, point of view or styles of the book; a character map for inputing information relating to the characters of the book; a plot diagram for inputing information relating the plots of the book; a timeline for inputing information relating to a sequence of events of the book; a Venn diagram; and a game.

18. A method according to claim 17, wherein the game comprises a crossword puzzle, word find, word jumble, matching game, action video game, maze and decoder puzzle.

19. A method according to claim 1, wherein the after-reading exercises comprise a reflection exercise, summary exercise, discussion exercise, question and answer exercise, a chart of questions comrpising why, what, where, when and who questions; a story organizer for inputing information relating to the characters, settings, style, plots, points of view and themes of the book; a character map for inputing information relating to characters of the book; a plot diagram for inputing information relating a plot of the book; a timeline for inputing information relating to a sequence of events of the book; a Venn diagram; and a game.

20. A method according to claim 19, wherein the game comprises a crossword puzzle, word find, word jumble, matching game, action video game, maze and decoder puzzle.

21. A method according to claim 19, wherein the reflection exercise comprises a series of subjective reflection questions concerning the book directed to a reader.

22. A method according to claim 21, wherein the reflection questions comprise “did you learn anything new?”; “which characters did you like, and why?”; “did you like the story and would you recommend it to a friend?”.

23. A method according to claim 21, wherein the method further comprises inputing into a computer answers corresponding to the reflection questions.

24. A method according to claim 19, wherein the summary exercise comprises preparing a summary of at least a part of the book or drawing a picture, the summary or picture comprising details of the characters, plots or settings of the book.

25. A method according to claim 24, wherein the summary exercise comprises inputing into a computer the summary of the book or drawing.

26. A method according to claim 19, wherein the discussion exercise comprises instructions for a reader to have a discussion of the book with another person.

27. A method according to claim 26, further comprising inputing into a computer a summary of the discussion.

28. A method according to claim 19, wherein the question and answer exercise comprises a plurality of objective questions relating to details of the author, characters, plots, settings, themes, point of view, or styles of the book.

29. A method according to claim 1, wherein the computer program comprises a plurality of sections, each section associated with a different book, the method further comprising selecting a section and corresponding pre-selected book.

30. A method according to claim 29, wherein the sections and associated books are related by author, genre, period, difficulty level or age-category.

31. A method according to claim 1, wherein the computer program is adapted to allow an instructor to customize the program, before-reading, during-reading or after-reading exercises, wherein the instructor can select from a plurality of books, select from a plurality of before-reading, during-reading, or after-reading exercises, select a difficulty level of the exercises, or input customized explanations, instructions, tasks or questions as part of the before-reading, during-reading or after-reading exercises.

32. A method according to claim 1, wherein the computer program is adapted to allow a reader to select from a plurality of sections, each section corresponding to a different pre-selected book and providing, for each pre-selected book, before-reading, during-reading and after-reading exercises related to each book.

33. A method according to claim 1, wherein the computer program is capable of comparing responses provided by a reader in connection with the before-reading, during-reading or after-reading exercises to correct responses stored in a memory of a computer, the method further comprising providing to a reader or instructor feedback on performance of the before-reading, during-reading or after-reading exercises.

34. A method according to claim 1, wherein the computer program further provides at least one resource, the resource comprising biographical information about the author, historical information about the settings, characters, or plots upon which the book is based, book reviews, a dictionary, thesaurus, foreign language dictionary, encyclopedia, or maps; the method further comprising selecting the resource or resources provided and reviewing information contained therein.

35. A method according to claim 34, wherein the resources further comprise at least one link to a website containing information related to the book.

36. A computer-based method of teaching reading comprehension to a student, comprising:
presenting to the student on a display of a computer selections of pre-reading, during-reading and post-reading exercises associated with a pre-selected book to be read and comprehended by the student;
selecting at least one of the pre-reading exercises on the computer, the pre-reading exercises comprising pre-reading comprehension activities specifically related to the pre-selected book, the pre-reading activities to be performed by the student prior to reading the book; displaying instructions for the reading comprehension activities to the student on the display; and having the student provide one or more responses to the pre-reading comprehension activities;
selecting at least one of the during-reading exercises on the computer, the during-reading exercises comprising during-reading comprehension activities specifically related to the pre-selected book, the during-reading activities to be performed by the student based on portions of the book already read by the student; displaying instructions for the during-reading activities to the student on the display; and having the student provide one or more responses to the during-reading activities; and
selecting at least one of the post-reading exercises on the computer, the post-reading exercises comprising post-reading comprehension activities specifically related to the pre-selected book, the post-reading activities to be performed by the student based on the student's reading of the entire book; displaying instructions for the post-reading activities to the student on the display; and having the student prepare one or more responses to the post-reading exercises.

37. A method according to claim 36, wherein the one or more responses to the pre-reading, during-reading and post-reading exercises are electronically stored.

38. A method according to claim 36, wherein correct responses to the pre-reading, during-reading and post-reading activities are electronically stored and displayed to the student after the student's responses have been provided.

39. A method according to claim 36, wherein the pre-reading activities include one or more of a preview, connect, purpose and plan activity.

40. A method according to claim 39, wherein the preview activity comprises at least one of the following: reading a title of the book; reading information about an author of the book; reviewing front and back covers of the book; reading summaries or reviews of the book; reading a preface of the book; reading a table of contents of the book; reading chapter titles of the book; and viewing illustrations of the book,
and wherein the one ore more responses comprises providing an indication to the computer that the preview activity has been completed.

41. A method according to claim 39, wherein the connect activity comprises an activity wherein the student is instructed by the computer to identify at least one detail about a character, title, author, setting, theme or plot of the book that relates to a personal experience of the student, and wherein the one or more responses comprise providing an indication to the computer that the connect activity has been completed.

42. A method according to claim 39, wherein the purpose activity comprises directing the student by the computer to identify a question that the reader believes can be answered from details about an author, setting, plot, theme or character of the book, and wherein the one or more responses comprise providing an indication to the computer that the purpose activity has been completed.

43. A method according to claim 39, wherein the plan activity comprises activities for the student to perform relating to techniques for organizing details concerning an author, style, point of view, plot, theme, setting or character of the book, the techniques comprising one or more of: a chart of questions presented by the computer to the student comprising why, what, where, when and who questions; a story organizer for inputing information into the computer relating to the characters, settings, style, plots, points of view and themes of the book; a character map for inputing information into the computer relating to characters of the book; a plot diagram for inputing information into the computer relating to a plot of the book; a timeline for inputing information into the computer relating to a sequence of events of the book; and a Venn diagram, and
wherein the one or more responses comprises inputing information into the computer, providing an indication that the plan activity has been completed.

44. A method according to claim 36, wherein the during-reading activities comprise one or more of: a chart of questions pertaining to why, what, where, when and who questions; a story organizer for inputing information into the computer relating to the characters, settings, styles, plots, points of view or themes of the book; a character map for inputing information into the computer relating to characters of the book; a plot diagram for inputing into the computer information relating a plot of the book; a timeline for inputing information into the computer relating to a sequence of events of the book; a Venn diagram; and a game; and
wherein the one or more responses comprises inputing information into the computer, providing an indication that the during-reading activitiess have been completed.

45. A method according to claim 44, wherein the game comprises a crossword puzzle, word find, word jumble, matching game, action video game, maze or decoder puzzle.

46. A method according to claim 36, wherein the after-reading activities comprise one or more of (a) a reflection activity; (b) summary activity; (c) discussion activity; (d) question and answer activity; (e) a chart of questions pertaining to why, what, where, when and who questions; (f) a story organizer for inputing information into the computer relating to the characters, settings, style, plots, points of view and themes of the book; (g) a character map for inputing information into the computer relating to characters of the book; (h) a plot diagram for inputing information into the computer relating to a plot of the book; (i) a timeline for inputing into the computer information relating to a sequence of events of the book; (j) a Venn diagram; and (k) a game, and
wherein the one or more responses comprises inputing information into the computer, providing an indication that the after-reading activity has been completed.

47. A method according to claim 46, wherein the game comprises a crossword puzzle, word find, word jumble, matching game, action video game, maze or decoder puzzle.

48. A method according to claim 46, wherein the reflection activity comprises a series of subjective questions concerning the book.

49. A method according to claim 46, wherein the questions of the question and answer activity comprise “did you learn anything new?”; “which characters did you like, and why?”; and “did you like the story and would you recommend it to a friend?”.

50. A method according to claim 46, wherein the summary activity comprises preparing a summary of the book or drawing a picture comprising details of the plot, settings, or characters of the book.

51. A method according to claim 46, wherein the discussion activity comprises instructions for the student to participate in a discussion of the book with another person.

52. A method according to claim 51, wherein the discussion occurs electronically over a network.

53. A computing device for improving reading comprehension comprising:
a user interface for communicating information to a user of the computing device;
a user input device; and
a processor provided with a computer program that causes the computer to:
display before-reading, during-reading, and after-reading exercises to be completed in association with a pre-selected book, at least one of the exercises specifically corresponding to details of a author, character, plot, setting, theme, point of view, or style of the pre-selected book.

54. The computing device of claim 53, wherein the computing device comprises a PC, PDA, cell phone or gaming console.

55. The computing device of claim 53, wherein the user interface comprises a display screen or an audio speaker.

56. The computing device of claim 53, wherein the user input device comprises a keyboard, mouse, touchpad, stylus or microphone.

57. The computing device of claim 53, wherein the processor is provided with a second computer program that causes the computing device to present the pre-selected book on the computing device to the student.

58. A storage medium storing a computer-executable program for improving reading comprehension skills, wherein the program contains instructions for causing a computer to display to the user before-reading, during-reading, and after-reading exercises to be completed in association with a pre-selected book, at least one of the exercises corresponding to details of a plot, author, settings, characters, themes or style of the pre-selected book.

59. A system for improving reading comprehension skills, comprising:
a server computer;
a plurality of user computers connected to the server computer via a communications network, each of the user computers comprising a user interface for communicating information to a user of the user computer, a user input device, a display device, and a processor;
wherein the server computer comprises a processor programmed to send instructions via the communications network to the user computers, the instructions causing the processor of the user computer to display before-reading, during-reading, and after-reading exercises to be completed in association with a pre-selected book, at least one of the exercises specifically corresponding to details of a author, character, plot, setting, theme, point of view, or style of the pre-selected book.

60. A method according to claim 1, wherein the computer program is adapted to request and receive input of personal information relating to the student and store the personal information in a memory, and wherein one or more of the before-reading, during-reading, or after-reading exercises integrates the personal information of the student into the exercises.
